(19) United States
(12) Patent Application Publication
(10) Pub. No.: US 2017/0090727 A1
(43) Pub. Date: Mar. 30, 2017

(54) ELECTRONIC DEVICE, DEVICE COMPUTER READABLE RECORDING MEDIUM, AND DEVICE CONTROL METHOD

(71) Applicant: FUJITSU LIMITED, Kawasaki-shi (JP)

(72) Inventor: Toshiyuki MASHINO, Kawasaki (JP)

(21) Appl. No.: 15/273,153

(22) Filed: Sep. 22, 2016

(30) Foreign Application Priority Data
Sep. 24, 2015 (JP) 2015-186573

(51) Int. Cl. G06F 3/0484; G06F 3/0488; G06F 17/22

(52) U.S. Cl. CPC G06F 3/04842; G06F 17/2247; G06F 3/04883

(57) ABSTRACT

An electronic device comprising: a memory, and a processor coupled to the memory and the processor configured to: display an object to a display screen, and control, when an operation for selecting the object is detected, execution of a processing associated with the object based on a time difference between a first time at which the object is displayed and a second time at which the object is selected.

### CROSS-REFERENCE TO RELATED APPLICATION

This application is based upon and claims the benefit of priority of the prior Japanese Patent Application No. 2015-186573, filed on Sep. 24, 2015, the entire contents of which are incorporated herein by reference.

### FIELD

The embodiments disclosed herein are related to an electronic device, a device control program, and a device control method.

### BACKGROUND

Some of communication terminals such as a smartphone and a tablet terminal that include a communication function come with a function to detect the orientation of the communication terminal and according to the detected orientation change the orientation of a screen, such that the user can easily read the screen. However, for example, there is a case in which an orientation of a communication terminal is unintentionally changed when a user was about to press a button on a touch panel on the screen. For this reason, a method has been disclosed that disables pressing of a touch panel by the user when the orientation of the screen is changed until after a pre-set time elapses.

Japanese Laid-open Patent Publication No. 2013-20532 is the related art.

### SUMMARY

According to an aspect of the invention, an electronic device comprising: a memory, and a processor coupled to the memory and the processor configured to: display an object to a display screen, and control, when an operation for selecting the object is detected, execution of a processing associated with the object based on a time difference between a first time at which the object is displayed and a second time at which the object is selected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1. is a diagram illustrating an example of a configuration of a communication terminal according to a first embodiment;

FIG. 2 is a diagram illustrating an example of screen configuration information;

FIG. 3 is a diagram illustrating an example of screen configuration information;

FIG. 4 is a diagram illustrating an example of a configuration when a communication terminal is realized by a computer;

FIG. 5 is a flowchart illustrating an example of a flow of paint processing;

FIG. 6 is a flowchart illustrating an example of a flow of distribution control processing according to the first embodiment;

FIG. 7 is a diagram illustrating an example of an UI object selection operation in the communication terminal according to the first embodiment;

FIG. 8 is a diagram illustrating an example of a configuration of a communication terminal according to a second embodiment;

FIG. 9A to 9C are diagrams each illustrating an example of storage management of screen configuration information by a ring buffer;

FIG. 10 is a flowchart illustrating an example of a flow of distribution control processing according to the second embodiment;

FIG. 11 is a flowchart illustrating an example of a flow of gesture coordinates correction processing;

FIG. 12 is a flowchart illustrating an example of a flow of correction amount calculation processing;

FIG. 13 is a flowchart in a modified example of the gesture coordinates correction processing;

FIG. 14 is a diagram illustrating an example of an UI object selection operation in the communication terminal according to the second embodiment;

FIG. 15 is a diagram illustrating an example of screen configuration information; and

FIG. 16 is a schematic diagram illustrating an example of erroneous selection of an UI object.

### DESCRIPTION OF EMBODIMENTS

However, the method described above is a technology to addresses a case in which the orientation of screen changed just before an operation by the user, and not able to address changes in the screen other than the change in its orientation.

For example, when browsing web pages and so on using a communication terminal, and when the reception status of data is not good, displaying all information on the screen takes time, during which the screen may be updated according to the data that has been received.

Under such a circumstance, for example, before a screen displays all information, the screen can be updated just before the user pressed an object, resulting in an object (for example, another button) not intended by the user to be press operated.

One aspect of the objective of the technology disclosed herein is to suppress execution of processing according to an operation not intended by the user, when the screen is displayed in phases before acquisition of screen data is completed.

Embodiments of the technology disclosed herein are described below in detail with reference to drawings. Note that the same symbol is applied to a configuration element or processing having a similar function, throughout all of the drawings, and a duplicated description may be omitted as appropriate.

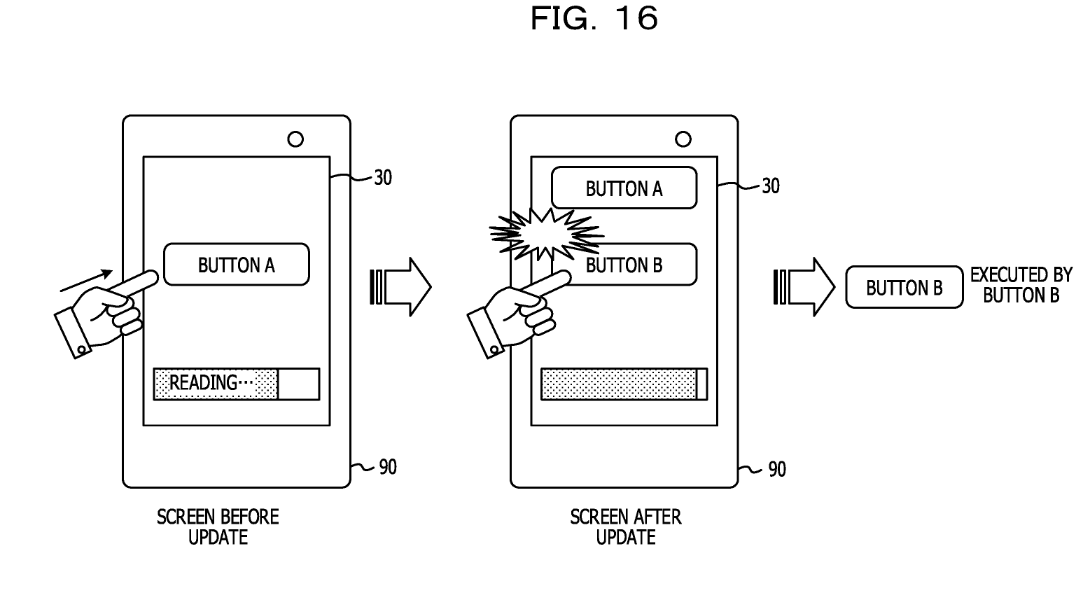

FIG. 16 is a diagram illustrating an example of incorrect selection of an unintended object, such as a case in which a screen of a display device 30 updated just before an object that has been displayed on the screen was pressed.

As illustrated in FIG. 16, an example of a screen of the communication terminal 90 before the screen display is updated illustrates a state in which a button A is displayed on the screen, and the user is about to press and select the button A.

In such a state, when the communication terminal receives the rest of the contents-related data before the button A is pressed, the screen is updated and there is a case in which another object, for example, a button B, is displayed at the position where the button A was displayed before the screen update.

Accordingly, in some cases, the user mistakenly selects the button B (namely, an operation for selecting the button B is detected based on user's mistake), not the button A that the user intended to select, causing processing associated with the button B to be executed.

An explanation follows, as in the example illustrated in FIG. 16, regarding a communication terminal capable of suppressing execution of processing according to an unintended operation, even when the screen is displayed in phases before acquisition of the screen display data is completed.

### First Embodiment

In many cases, in a communication terminal, for example, a browsing application (browser) is installed. The browsing application analyzes information (contents) received from a server connected to the internet, and displays the received contents on the communication terminal screen. The contents displayed on the communication terminal screen includes, for example, configuration elements displayed on the screen such as an image and a character. Hereinafter, each of the configuration elements of the contents displayed on the communication terminal screen is referred to as “user interface (UI) object”. In addition, a screen finally displayed for the contents is referred to as a “display screen”.

There are various types of UI objects such as a text and an image, and the UI objects includes configuration elements that can be operated using a mouse or a touch panel by the user such as a button and a checkbox.

Explanation follows regarding processing by a communication terminal that displays contents received from the server connected to the internet on the screen, and accepts a user operation of a UI object included in the contents.

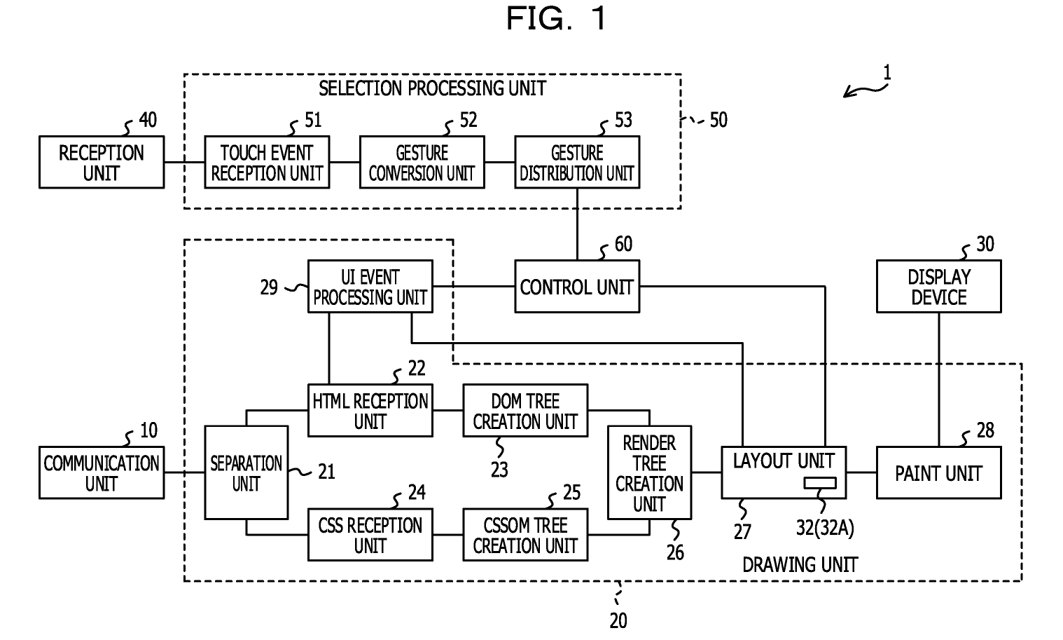

FIG. 1 is a diagram illustrating an example of a configuration of a communication terminal 1 according to the first embodiment. As illustrated in FIG. 1, the communication terminal 1 includes a communication unit 10, a drawing unit 20, the display device 30, a reception unit 40, a selection processing unit 50, and a control unit 60.

The communication unit 10 is connected to a separation unit 21, described later, of the drawing unit 20, and for example, receives specified contents from a certain server connected to the internet and provides the specified contents to the separation unit 21.

Here, as an example, it is assumed in the explanation that contents are received from a server on the internet, but contents may be received from an intranet that is a certain intra-organization network. In addition, a mode of connection with the internet or the intranet may employ any connection method such as a wired connection, a wireless connection, or a mixture of the wired and the wireless connections.

A markup language may be used to create the contents received by the communication unit 10. A markup language defines a display layout such as the position to display, type, size, and color of the font, of a UI object on the communication terminal 1 screen. As the markup language to create the contents, for example, hypertext markup language (HTML) and cascading style sheets (CSS) are used. The contents are an example of data configuring the display screen of the technology disclosed herein, and may include image data, video data, and audio data in addition to the markup language.

HTML is a language that provides the browser with an instruction related to information structure such as what UI object to display on the screen, and so on. In contrast, CSS is a language that provides the browser with an instruction related to decoration such as where and how a UI object instructed by HTML is displayed on the screen.

Thus, the drawing unit 20 analyzes contents received from the communication unit 10 by dividing them into the information structure specified by HTML and decoration specified by the CSS, and draws the specified UI object in the specified display layout on the display device 30 screen.

Accordingly, the drawing unit 20 includes the separation unit 21, an HTML reception unit 22, a DOM tree creation unit 23, a CSS reception unit 24, a CSSOM tree creation unit 25, a render tree creation unit 26, a layout unit 27, a paint unit 28, and a UI event processing unit 29. Note that, “DOM” is an abbreviation for a document object model, and “CSSOM” is an abbreviation for a cascading style sheets object model.

The separation unit 21 is connected to the communication unit 10, the HTML reception unit 22, and the CSS reception unit 24. The separation unit 21 separates the contents received from the communication unit 10 into information described in HTML (HTML information) and information described in CSS (CSS information), and provides the HTML information to the HTML reception unit 22 and provides the CSS information to the CSS reception unit 24.

The HTML reception unit 22 is connected to the separation unit 21, the DOM tree creation unit 23, and the UI event processing unit 29.

The HTML reception unit 22 analyzes the HTML information received from the separation unit 21, and obtains processing to be executed for each UI object included in the contents when such UI object is selected. The HTML reception unit 22 provides the processing contents corresponding to each of the obtained UI objects to the UI event processing unit 29, associating the processing contents with the respective UI object name.

Here, the UI object name is, for example, a name assigned to identify a UI object in the HTML information. For example, in case of a code for displaying a button that, when selected, executes a function “func1 ( )”: <input type=“button” name=“button1” value=“button1” onClick=func1 ( )>, “button1” indicated by a name attribute is the UI object name. In addition, the function “func1 ( )” is the processing contents corresponding to “button1”.

In addition, the HTML reception unit 22 shapes the HTML information accepted from the separation unit 21 into a description format that can be read by the DOM tree creation unit 23, and provides the HTML information to the DOM tree creation unit 23.

The DOM tree creation unit 23 is connected to the HTML reception unit 22 and the render tree creation unit 26.

The DOM tree creation unit 23 divides the HTML information accepted from the HTML reception unit 22 into units of nodes. Here, the node refers to, for example, each element configuring the HTML information such as an HTML tag of <html> or <body>, an attribute described in the HTML tag (for example, href attribute of <A>tag or src attribute of <img>tag), and a text.

Then, the DOM tree creation unit 23 creates, with the document node that illustrates the whole HTML information as the root, a layer structure (DOM tree) of nodes included in the HTML information. The DOM tree creation unit 23 provides the created DOM tree to the render tree creation unit 26.

The CSS reception unit 24 is connected to the separation unit 21 and the CSSOM tree creation unit 25. The CSS reception unit 24 shapes the CSS information accepted from the separation unit 21 into a description format that can be read by the CSSOM tree creation unit 25, and provides the CSS information to the CSSOM tree creation unit 25.

The CSSOM tree creation unit 25 is connected to the CSS reception unit 24 and the render tree creation unit 26.

The CSSOM tree creation unit 25 analyzes the CSS information accepted from the CSS reception unit 24, creates a layer structure (CSSOM tree) of a CSS structure body (CSSOM) in which the display layout is defined, and provides the created CSSOM tree to the render tree creation unit 26.

The render tree creation unit 26 is connected to the DOM tree creation unit 23, the CSSOM tree creation unit 25, and the layout unit 27.

The render tree creation unit 26 accepts the DOM tree from the DOM tree creation unit 23, and accepts the CSSOM tree from the CSSOM tree creation unit 25. The render tree creation unit 26 associates nodes of the DOM tree with the CSS structure body of the CSSOM tree, and creates a layer structure (render tree), in which nodes that are displayed on the display device 30 and visually recognizable, out of each node, are arranged together with the CSS structure body in the order of display.

Note that the render tree is the information that only defines the display order of visually recognizable nodes, namely, UI objects. The render tree does not specify size of a UI object or position at which a UI object is displayed on the display device 30 screen.

The render tree creation unit 26 provides the created render tree to the layout unit 27.

The layout unit 27 is connected to the render tree creation unit 26, the paint unit 28, the UI event processing unit 29, and the control unit 60.

The layout unit 27 determines size of the UI object and the position at which the UI object is displayed on the display device 30 screen, based on the CSS structure body of the render tree accepted from the render tree creation unit 26 and the pre-defined screen size information of the display device 30.

In addition, the layout unit 27 creates screen configuration information 32 in which size and display position on the screen of each UI object are recorded.

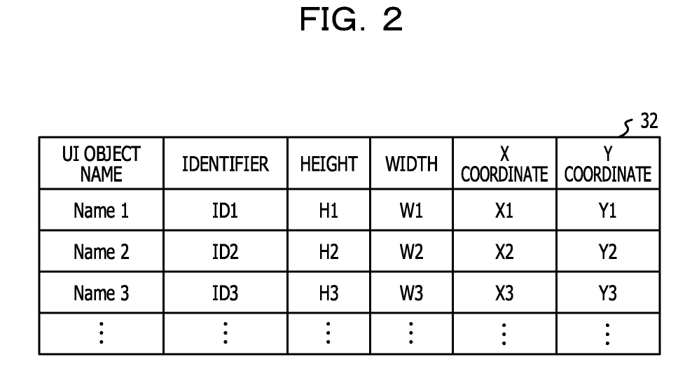

FIG. 2 is a diagram illustrating an example of the screen configuration information 32.

The screen configuration information 32 includes, for example, UI object name in the HTML information, identifier to specify the UI object, and information recording the height and the width of the UI object, for each of the UI objects. In addition, the screen configuration information 32 includes information to record the X coordinate and the Y coordinate of the UI object on the display device 30 screen. Note that the information recorded in the screen configuration information 32 illustrated in FIG. 2 is but an example, and for example, may include other information such as a color in which the UI object is drawn.

Here, the UI object name indicates the name of node corresponding to the UI object, and the X coordinate and the Y coordinate of the UI object indicate, for example, coordinates of a position pre-defined for each type of UI objects (when the UI object is a button, for example, upper left position thereof). The X coordinate and the Y coordinate of the UI object indicate coordinates in an XY coordinate system in which the screen horizontal direction is set as an X axis and the screen vertical direction is set as a Y axis, for example, with the top left of the display device 30 screen set as an origin point. Such a coordinate system in which the coordinates of the UI object are defined is but an example, and it is obvious that, for example, another coordinate system with the top right of the screen set as the origin point may be used. The X coordinate and the Y coordinate of the UI object is set according to an applied coordinate system.

In this manner, the screen configuration information 32 indicates size of the UI object by the height and the width information, and the screen configuration information 32 indicates the display position of the UI object on the display device 30 screen by the X coordinate and the Y coordinate.

The layout unit 27 creates the screen configuration information 32, and then provides a drawing request to the paint unit 28.

The paint unit 28 is connected to the layout unit 27 and the display device 30, and when the paint unit 28 accepts the drawing request from the layout unit 27, the paint unit 28 draws the contents including the UI object on the display device 30 screen based on the screen configuration information 32 created by the layout unit 27.

In addition, the paint unit 28 records the time (display time) at which the drawing of the UI object on the display device 30 screen is finished, for each of the UI objects, and generates screen configuration information 32A.

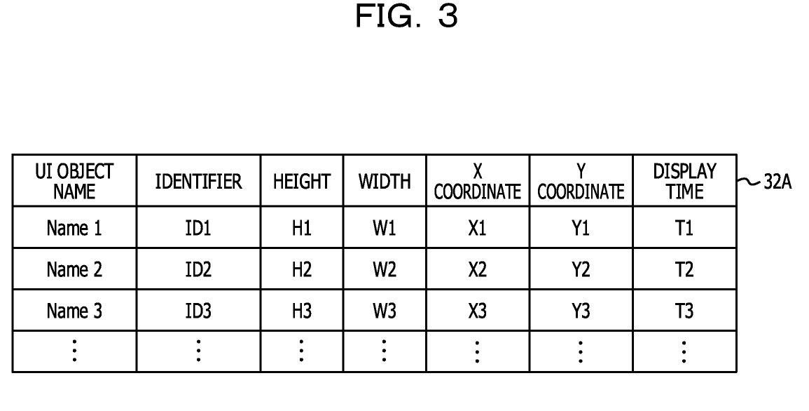

FIG. 3 is a diagram illustrating an example of the screen configuration information 32A. As illustrated in FIG. 3, in the screen configuration information 32A, display time is associated with each of the UI objects. For example, a display time Tn (n=1, 2, . . . ) is indicated as “hour:minute:second” such as “10:18:59”. However, the recording format of the display time Tn is not limited thereto, and the recording in a unit of up to milliseconds or microseconds may be performed.

Note that, as an example, the display time is set as the time at which drawing the UI object on the display device 30 screen finished. However, for example, the display time may be set as the time at which drawing the UI object and the like started.

The UI event processing unit 29 is connected to the HTML reception unit 22, the layout unit 27, and the control unit 60 described later.

As described with reference to the HTML reception unit 22, the UI event processing unit 29 accepts the processing contents corresponding to each of the UI objects from the HTML reception unit 22, and manages, for each of the UI objects, the processing contents to be executed when the UI object has been selected.

When the UI event processing unit 29 accepts from the control unit 60, for example, coordinates indicating the position selected by the user on the display device 30 screen, the UI event processing unit 29 identifies an UI object located on the coordinates with reference to the screen configuration information 32A of the layout unit 27.

Specifically, for example, the UI event processing unit 29 obtains respective values of height, width, X coordinate, and Y coordinate, for example, on each line of the screen configuration information 32A illustrated in FIG. 3, and calculates a display range of the UI object on the screen. Then, when the coordinates accepted from the control unit 60 are within the display range of the UI object, the UI event processing unit 29 determines that the UI object that includes the coordinates within its display range as an UI object located on the coordinate.

The UI event processing unit 29 refers to the processing contents corresponding to the determined UI object name, and executes processing in accordance with the processing contents. Note that the UI event processing unit 29 is an example of a processing unit in the technology disclosed herein.

The drawing processing of contents in the drawing unit 20 is further described below.

When contents are acquired from a server connected to the internet, contents acquisition time can sometimes vary depending on a communication environment.

For example, time taken to complete acquisition of contents in entirety can be prolonged as a communication band of a communication line connecting between the communication terminal 1 and the server connected to the internet becomes narrower. When a wireless line is used as the communication line, time taken to complete acquisition of contents in entirety can be prolonged as the reception conditions of radio waves deteriorate.

The number of users who feel stress from the display wait time generally increases as a display wait time after instructing acquisition of the contents until drawing of the contents is started on the display device 30 becomes longer.

Accordingly, rather than starting to draw the contents on the screen only after acquiring the contents in their entirety, when at least a part of the contents is acquired, the drawing unit 20 creates the screen configuration information 32 and updates the drawing of the contents. The communication terminal 1 thereby displays the received contents on the display device 30 screen in phases, according to the reception status.

The reception unit 40, connected to an input device not illustrated in the drawings and to the selection processing unit 50, accepts the coordinates on the display device 30 screen (touch event coordinates) selected by the user, from the input device not illustrated in the drawings.

As the input device, for example, a touch panel installed on the display device 30 screen is used, but the input device is not limited to a touch panel. For example, any device that can specify a position on the display device 30 screen such as a mouse or a sight line detection device may be used as the input device.

When the reception unit 40 accepts the touch event coordinates from the input device that is not illustrated, the reception unit 40 provides the touch event coordinates to the selection processing unit 50.

The selection processing unit 50 includes a touch event reception unit 51, a gesture conversion unit 52, and a gesture distribution unit 53, and converts the touch event coordinates received from the reception unit 40 into gesture coordinates, and provides the gesture coordinates to the control unit 60.

For example, there is a case in which a finger of the user moves while selecting a part of the display device 30 screen by pressing the touch panel with the finger. In this case, the selection processing unit 50 receives plural touch event coordinates from a single selection operation by the user, and a state occurs in which the position on the screen intended by the user to be selected is unclear. Accordingly, the selection processing unit 50 calculates the position on the screen intended by the user to be selected, namely the gesture coordinates, based on the touch event coordinates received from the reception unit 40 in a time period considered to be desired for a single selection operation by the user (selection time period).

The touch event reception unit 51 is connected to the reception unit 40 and the gesture conversion unit 52. When the touch event reception unit 51 accepts the touch event coordinates, the touch event reception unit 51 checks whether plural touch event coordinates are received since the receipt of the touch event coordinates until the selection time period elapses, and provides the received touch event coordinates to the gesture conversion unit 52. When plural touch event coordinates are received in the selection time period, the touch event reception unit 51 provides all of the touch event coordinates received in the selection time period to the gesture conversion unit 52.

The gesture conversion unit 52 is connected to the touch event reception unit 51 and the gesture distribution unit 53, and converts the touch event coordinates accepted from the touch event reception unit 51 into the gesture coordinates. Note that there is no limitation for a method of conversion from touch event coordinates into gesture coordinates, and for example, a method such as the one in which average coordinates of the plural touch event coordinates are set as the gesture coordinates, is employed. Otherwise, as a modified example, the touch event coordinates may be used as the gesture coordinates as they are. Namely, the gesture conversion unit 52 may be omitted, and the touch event coordinates that the touch event reception unit 51 accepted from the reception unit 40 may be provided to the gesture distribution unit 53 as the gesture coordinates as they are.

The gesture conversion unit 52 provides the calculated gesture coordinates to the gesture distribution unit 53.

The gesture distribution unit 53 is connected to the gesture conversion unit 52 and the control unit 60. The gesture distribution unit 53 notifies the control unit 60 of selection of a particular UI object by the user by providing the gesture coordinates accepted from the gesture conversion unit 52 to the control unit 60.

The control unit 60 is connected to the gesture distribution unit 53, the UI event processing unit 29, and the layout unit 27. When the control unit 60 accepts the gesture coordinates from the gesture distribution unit 53, the control unit 60 identifies the UI object selected by the user, using the gesture coordinates and the screen configuration information 32A.

Then, when the accepted gesture coordinates are gesture coordinates accepted before a specified time period elapses since the display time of the selected UI object, the control unit 60 discards the gesture coordinates. In contrast, when the accepted gesture coordinates are gesture coordinates accepted after the specified time period has elapsed since the display time of the selected UI object, the control unit 60 provides the gesture coordinates to the UI event processing unit 29. Hereafter, the UI event processing unit 29 executes the above-described processing, and executes processing associated with the selected UI object.

In this manner, the communication terminal 1 draws the contents acquired through a communication line on the display device 30 screen, recognizes an UI object on the screen selected by the user, and executes the processing associated with the UI object.

The drawing unit 20 may be realized by a browser installed in the communication terminal 1. In addition, as the communication terminal 1, a device capable of displaying downloaded contents on the screen such as a smartphone, a tablet terminal, or a personal computer may be conceived of.

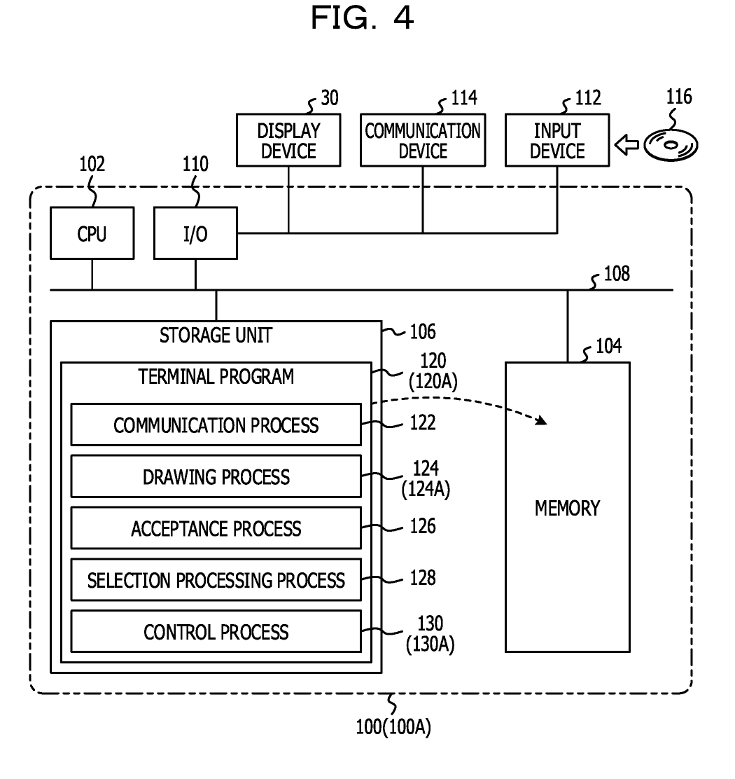

An example of a configuration diagram of the communication terminal 1 realized by a computer is described below with reference to FIG. 4.

A computer 100 includes a CPU 102, a memory 104, and a nonvolatile storage unit 106. The CPU 102, the memory 104, and the nonvolatile storage unit 106 are connected to each other through a bus 108. In addition, the computer 100 includes an Input/Output (I/O) 110 that connects an input device 112, a communication device 114, and the display device 30, to the computer 100 and performs transmission and reception of data. The I/O 110 is connected to the bus 108.

The input device 112 may include an input device such as a mouse, a touch panel, or the like through which the user of the computer 100 instructs the computer 100 the selected position on the display device 30 screen. In addition, the input device 112 may include, for example, a reading device used to read data recorded in a recording medium 116 such as a compact disc-read-only memory (CD-ROM) or a flash memory.

The communication device 114 includes, for example, a communication protocol used to transmit and receive data to and from a server connected to the communication line such as the internet, and receives contents from the specified server based on an instruction by a communication process described later. In the example of FIG. 4, the communication device 114 is illustrated as a device independent of the computer 100, but the communication device 114 may be included in the computer 100. Similarly, the display device 30 and the input device 112 may be included in the computer 100.

The storage unit 106 may be realized by a hard disk drive (HDD), a flash memory, or the like.

In the storage unit 106, a device control program 120 used to cause the computer 100 to function as the communication terminal 1 illustrated in FIG. 1 is stored. The device control program 120 stored in the storage unit 106 includes a communication process 122, a drawing process 124, a reception process 126, a selection processing process 128, and a control process 130.

The computer 100 operates as the communication terminal 1 illustrated in FIG. 1 due to the CPU 102 reading the device control program 120 from the storage unit 106, deploying the device control program 120 to the memory 104, and executing each of the processes included in the device control program 120.

In addition, due to the CPU 102 executing the communication process 122, the computer 100 operates as the communication unit 10 illustrated in FIG. 1. In addition, due to the CPU 102 executing the drawing process 124, the computer 100 operates as the drawing unit 20 illustrated in FIG. 1. In addition, due to the CPU 102 executing the reception process 126, the computer 100 operates as the reception unit 40 illustrated in FIG. 1. In addition, due to the CPU 102 executing the selection processing process 128, the computer 100 operates as the selection processing unit 50 illustrated in FIG. 1. In addition, due to the CPU 102 executing the control process 130, the computer 100 operates as the control unit 60 illustrated in FIG. 1.

The computer 100 may be realized, for example, by a semiconductor integrated circuit, and more specifically, an application specific integrated circuit (ASIC) or the like. In addition, a calendar function that manages time is included in the CPU 102, and in each of the processes included in the device control program 120, the current time may be acquired from the CPU 102 using an application programming interface (API) prepared in advance.

Next, operation of the communication terminal 1 according to the first embodiment is described below. The paint unit 28 of the drawing unit 20 in the communication terminal 1 executes paint processing in which the contents received from the communication unit 10 is drawn on the display device 30 screen.

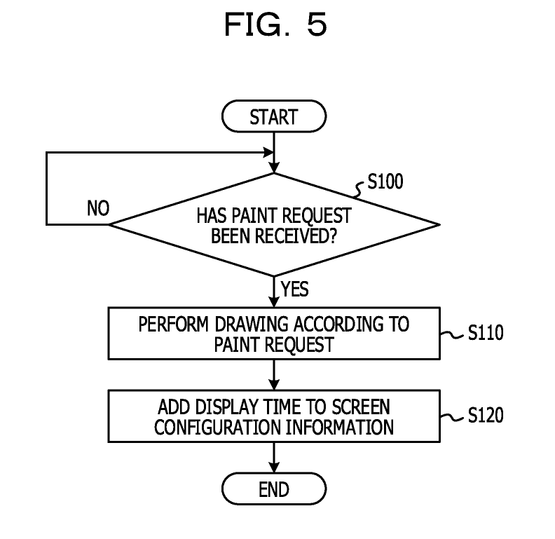

FIG. 5 is a flowchart illustrating an example of a flow of the paint processing in the paint unit 28.

In Step S100, the paint unit 28 determines whether or not a drawing request has been received from the layout unit 27, and the processing of Step S100 is repeated until a drawing request is received from the layout unit 27 when a drawing request has not been received from the layout unit 27, namely, when the determination result is negative. Conversely, when a drawing request has been received from the layout unit 27, namely, when the determination result is affirmative, the flow proceeds to Step S110.

In Step S110, the paint unit 28 draws the contents including the UI object on the display device 30 screen, based on the screen configuration information 32 created in the layout unit 27. Note that the screen configuration information 32 generated by the layout unit 27 is stored, for example, in the pre-defined area of the memory 104. At this time, the paint unit 28 stores a display time for each of the UI objects, for example, in the pre-defined area of the memory 104.

In Step S120, the paint unit 28 adds the display time stored in the memory in Step S110 to the display time field of the corresponding UI object in the screen configuration information 32, generates the screen configuration information 32A, and ends the paint processing. Note that the flow of the paint processing illustrated in FIG. 5 is an example, and as a modified example, the execution order between Steps S110 and S120 may be reversed.

On the other hand, the control unit 60 executes distribution control processing that controls whether or not to distribute the gesture coordinates to the UI event processing unit 29. The gesture coordinates are distributed from the gesture distribution unit 53 when the user presses the display device 30 screen on which the touch panel is installed.

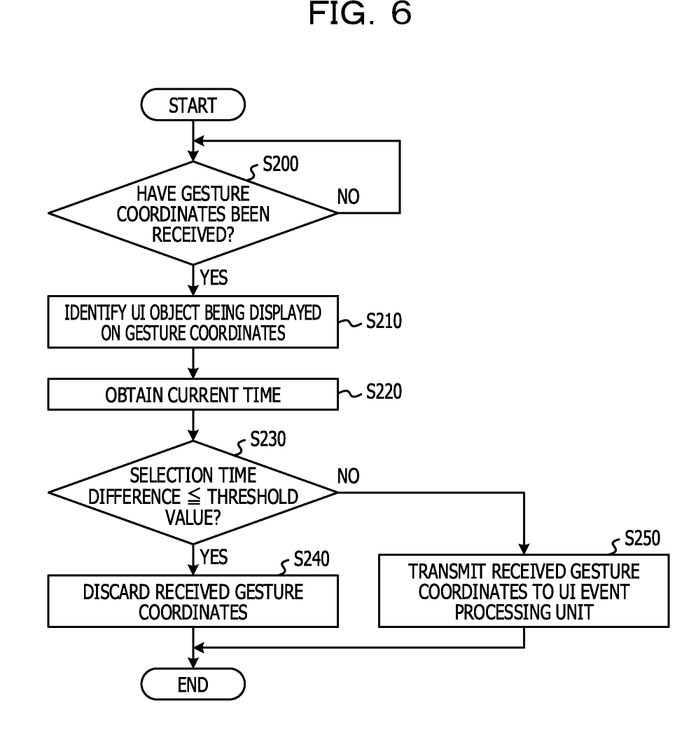

FIG. 6 is a flowchart illustrating an example of a flow of the distribution control processing in the control unit 60.

In Step S200, the control unit 60 determines whether or not the gesture coordinates have been received from the gesture distribution unit 53. When gesture coordinates have not been received from the gesture distribution unit 53, namely, when the determination result is negative in the determination processing of Step S200, the processing of Step S200 is repeated until gesture coordinates are received from the gesture distribution unit 53. Conversely, when gesture coordinates have been received from the gesture distribution unit 53, namely, when the determination result is affirmative in the determination processing of Step S200, the flow proceeds to Step S210.

In Step S210, the control unit 60 identifies an UI object located on the gesture coordinates out of the UI objects included in the screen configuration information 32A generated in Step S120 of FIG. 5, with reference to the screen configuration information 32A.

In Step S220, the control unit 60 acquires the current time from the CPU 102 using API. An acquiring method of the current time is not limited to such an example, and for example, the current time may be acquired from a time server connected to the internet.

In Step S230, the control unit 60 acquires a threshold value pre-stored in the pre-defined area of the memory 104.

The threshold value, from the time a UI object is displayed on the screen until the UI object is selected by the user, is set at a value under which a probability is considered high that the updating the contents would result in an erroneous selection of an object.

Then, the control unit 60 calculates a time difference (selection time difference) obtained by subtracting the display time of the UI object identified in Step S210 from the current time acquired in Step S220, and determines whether or not the selection time difference is the threshold value or less. When the selection time difference is the threshold value or less, namely, when the determination result is affirmative in the determination processing of Step S230, the flow proceeds to Step S240.

That the determination result is affirmative in the determination processing of Step S230 means that there is a probability that the user has selected the UI object in error after the UI object was displayed on the screen before a specified time period indicated by the threshold value has passed.

A user selects a UI object such as a button corresponding to the processing desired by the user, after having checked the contents displayed on the screen. Namely, in a human sensorimotor process, a reaction time (for example, hundreds of milliseconds) exists due to various processing stages, such as sensing the visual stimuli from the contents displayed on the screen, selection of judgement and response, and taking a reaction movement. Accordingly, it is normal that the control unit 60 receives gesture coordinates after the specified time period indicated by the threshold value has elapsed since the display of the UI object on the screen. In contrast thereto, the state in which the UI object is selected within the specified time period indicated by the threshold value after the display of a UI object on the screen can be considered due to the contents on the screen being updated just before the user selects the UI object.

Namely, it can be considered that, it is not the UI object located on the gesture coordinates on the display device 30 screen after the screen was updated, but the UI object located on the gesture coordinates before the screen was updated, that the user intended to select.

Accordingly, in Step S240, the control unit 60 discards the gesture coordinates received in Step S200 and ends the distribution control processing illustrated in FIG. 6.

On the other hand, when the selection time difference is larger than the threshold value, namely, when the determination result is negative in the determination processing of Step S230, the flow proceeds to Step S250.

In this case, it is considered that the user has selected the UI object intended by the user, because the user selected the UI object after the specified time period has elapsed after the display of the UI object on the screen.

Thus, in Step S250, the control unit 60 outputs the gesture coordinates received in Step S200 to the UI event processing unit 29. When the UI event processing unit 29 accepts the gesture coordinates from the control unit 60, the UI event processing unit 29 executes processing corresponding to the UI object located on the gesture coordinates.

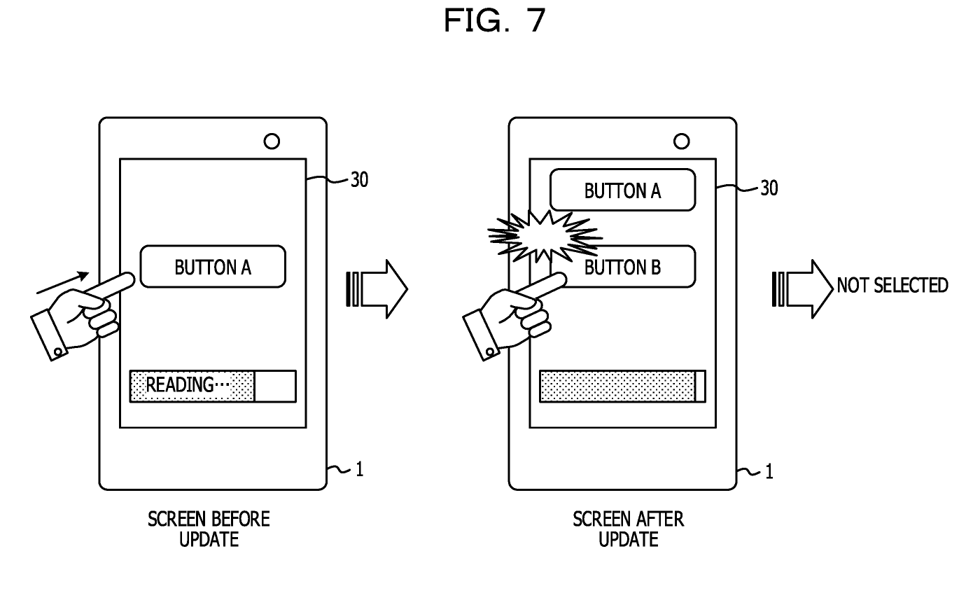

FIG. 7 is a diagram illustrating an example of a UI object selection operation in the communication terminal 1 when the selection time difference is the threshold value or less. When the user pressed the button B after the screen was updated due to the screen having been updated when the user was about to press the button A of the display device 30 before the screen was updated, the communication terminal 1 discards the gesture coordinates corresponding to the pressing of the button B. This enables the processing corresponding to the button B which is different from that of the button A that the user intended to select to be suppressed.

In this manner, in the communication terminal 1 according to the first embodiment, display time of a UI object included in the contents is recorded. Then, the communication terminal 1 calculates a selection time difference based on the display time of the UI object located on the gesture coordinates, notified when the user selected the screen, and the reception time of the gesture coordinates, and discards the gesture coordinates when the selection time difference is the threshold value or less.

Accordingly, the communication terminal 1 is capable of suppressing execution of processing according to an operation different from the intention of the user, for example, in a case in which a reception status when contents are received from the server connected to the internet is not good, causing the contents to be received in a fragmented manner and the screen updated in phases.

In addition, in the communication terminal 1, the threshold value according to the screen update frequency is set, by changing the threshold value according to a change in the reception speed of the contents. This thereby enables execution of processing according to the operation different from the intention of the user, as the screen is updated, to be further suppressed, compared to a case in which the threshold value is fixed.

### Second Embodiment

In the first embodiment, when a selection time difference is a threshold value or less, selection of a UI object different from a UI object that the user intends to select is suppressed by discarding gesture coordinates notified with the press of the screen.

In a second embodiment, when a selection time difference is a threshold value or less, selection of a UI object different from a UI object that the user intends to select is suppressed by correcting gesture coordinates notified with the press of the screen.

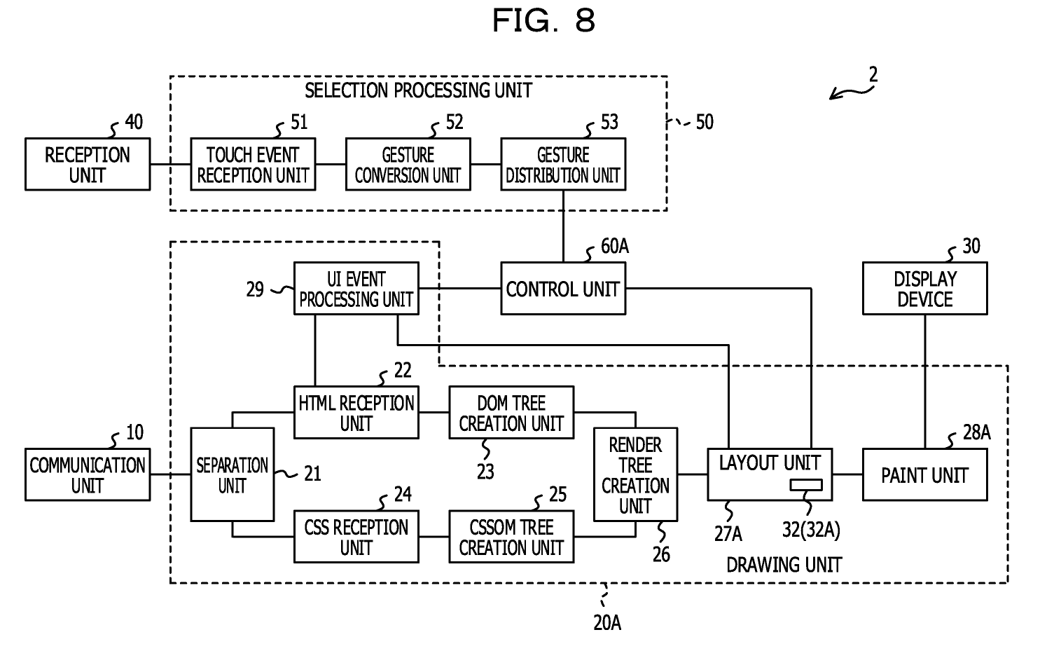

FIG. 8 is a diagram illustrating an example of a configuration of a communication terminal 2 according to the second embodiment. The configuration of the communication terminal 2 according to the second embodiment is different from the configuration of the communication terminal 1 according to the first embodiment illustrated in FIG. 1 in that the control unit 60 is replaced with a control unit 60A, and the layout unit 27 is replaced with a layout unit 27A. In addition, the paint unit 28 is replaced with a paint unit 28A. With the respective replacement of the layout unit 27 and the paint unit 28 with the layout unit 27A and the paint unit 28A, the drawing unit 20 is replaced with a drawing unit 20A.

Points of the communication terminal 2 according to the second embodiment different from the communication terminal 1 are mainly described below. A description of points similar to the communication terminal 1 is omitted herein.

The layout unit 27A is connected to the render tree creation unit 26, the paint unit 28A, the UI event processing unit 29, and the control unit 60A.

The layout unit 27A executes processing similar to that of the layout unit 27 according to the first embodiment. However, the layout unit 27A stores the created screen configuration information 32 in the ring buffer.

In addition, the paint unit 28A executes processing similar to that of the paint unit 28 according to the first embodiment, but the paint 28A records a display time for each of the UI objects included in the latest screen configuration information 32 stored in the ring buffer, and generates the screen configuration information 32A.

In addition, the control unit 60A is connected to the layout unit 27A, the UI event processing unit 29, and the gesture distribution unit 53.

When the control unit 60A accepts the gesture coordinates from the gesture distribution unit 53, the control unit 60A refers to the latest screen configuration information 32A corresponding to the contents that are being displayed on the display device 30, out of the screen configuration information 32A stored in the ring buffer. Then, the control unit 60A identifies an UI object located on the gesture coordinates from the latest screen configuration information 32A.

In addition, the control unit 60A calculates a selection time difference for the UI object located on the gesture coordinates. When the selection time difference is the threshold value or less, the control unit 60A refers to each of the screen configuration information 32A other than the latest screen configuration information 32A stored in the ring buffer, and identifies the UI object located on the gesture coordinates from each of the screen configuration information 32A.

Hereinafter, the UI object located on the gesture coordinates, which has been identified using the latest screen configuration information 32A, is referred to as “display UI object”. In addition, the UI object located on the gesture coordinates, which has been identified using each of the screen configuration information 32A other than the latest screen configuration information 32A, is referred to as a “comparison UI object”.

When at least one UI object with an identifier different from the identifier of the display UI object is included in each of the comparison UI objects, the control unit 60A corrects the gesture coordinates. Specifically, the control unit 60A corrects the gesture coordinates such that the gesture coordinates are included in a display area of a UI object having the same identifier as the comparison UI object in the latest screen configuration information 32A.

Next, a configuration of the communication terminal 2 realized by a computer is described. The configuration of the communication terminal 2 realized by the computer is similar to that of FIG. 4. However, accompanying the replacement of the drawing unit 20 with the drawing unit 20A, the drawing process 124 is replaced with a drawing process 124A. In addition, accompanying the replacement of the control unit 60 with the control unit 60A, the control process 130 is replaced with a control process 130A.

In addition, accompanying the replacement by the drawing process 124A and the replacement by the control process 130A, the device control program 120 is replaced with a device control program 120A.

A computer 100A operates as the communication terminal 2 due to the CPU 102 reading the device control program 120A from the storage unit 106, deploying the device control program 120A to the memory 104, and executing each of the processes included in the device control program 120A.

In addition, the computer 100A operates as the drawing unit 20A illustrated in FIG. 8 due to the CPU 102 executing the drawing process 124A. In addition, the computer 100A operates as the control unit 60A illustrated in FIG. 8 due to the CPU 102 executing the control process 130A.

The computer 100A may be realized, for example, by a semiconductor integrated circuit, more specifically, an ASIC or the like.

Next, an operation of the communication terminal 2 according to the second embodiment is described. It is assumed that the screen configuration information 32A for each screen update is already stored in the ring buffer by the processing of the paint unit 28A.

Here, the ring buffer is one of the storage forms using plural storage areas to stores data, and specifically, for example, is generated in a pre-defined area of the memory 104, as an array of storage areas.

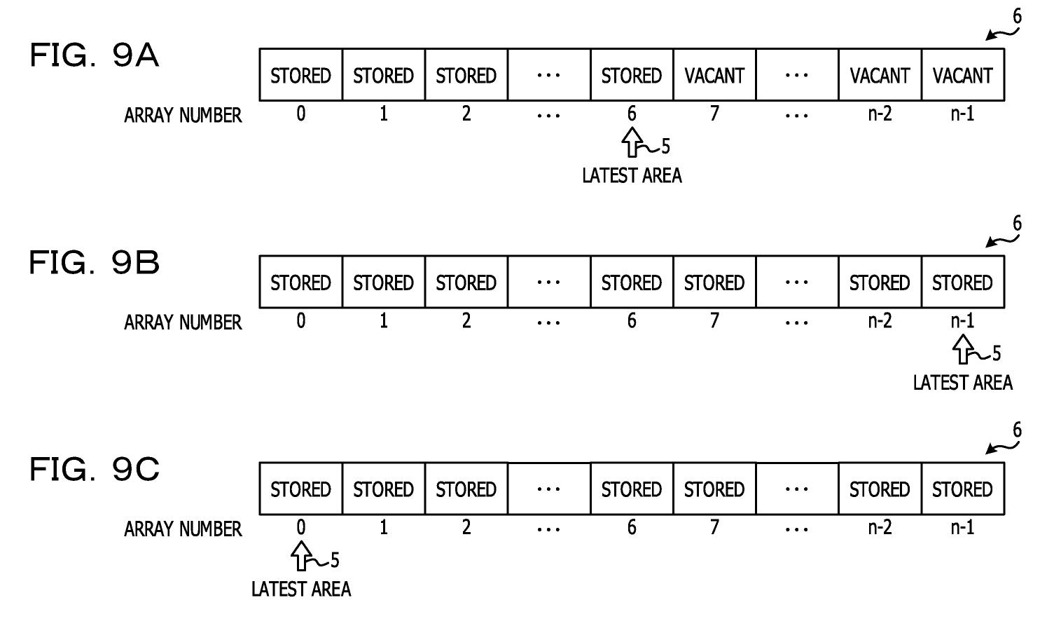

FIG. 9A to 9C are diagrams each illustrating an example of storage management of the screen configuration information 32A using a ring buffer 6. In FIGS. 9A to 9C, it is assumed that the number of storage areas of the ring buffer 6 is set as “n” (n is an integer that is two or more).

As illustrated in FIG. 9A, first, the layout unit 27A stores the screen configuration information 32 in a storage area having an array number 0, and then stores the screen configuration information 32 in order of a storage area having an array number 1, a storage area having an array number 2, and the like. Note that the layout unit 27A manages an index 5 indicating a storage destination (latest area) of the previously-stored screen configuration information 32.

In the example of FIG. 9A, the index 5 indicates a storage area having an array number 6, such that the latest screen configuration information 32A is stored in the storage area having the array number 6. In addition, the layout unit 27A determines a storage destination of the screen configuration information 32 that is to be stored next, based on the index 5. In the example of FIG. 9A, the index 5 indicates the storage area having the array number 6, such that the layout unit 27A stores the next screen configuration information 32 in a storage area having an array number next to the array number 6, namely, the storage area having the array number 7.

As illustrated in FIG. 9B, when the layout unit 27A stores the screen configuration information 32 to all of the storage areas of the ring buffer 6, the layout unit 27A returns a write destination of the screen configuration information 32 to the storage area having the smallest array number, namely, the storage area having the array number 0. Then, as illustrated in FIG. 9C, the layout unit 27A repeats processing in which n pieces of screen configuration information 32 are stored while consecutively overwriting the screen configuration information 32 onto the storage areas in order of the storage area having the array number 0 to the storage area having an array number (n−1).

Referring to the index 5 for each drawing of the contents, and for each of the UI objects included in the screen configuration information 32 of the latest area, the paint unit 28A records a time (display time) at which the drawing of the UI object on the display device 30 screen has completed, and the paint unit 28A generates the screen configuration information 32A. Thus, in the ring buffer 6, the screen configuration information 32A are stored in the chronological order. Note that the layout unit 27A initializes each of the storage areas included in the ring buffer 6 at a pre-defined value (initial value) when the communication terminal 2 is started up.

When the user presses the display device 30 screen on which the touch panel has been provided, the control unit 60A executes distribution control processing in which gesture coordinates distributed from the gesture distribution unit 53 are corrected according to a status and then distributed to the UI event processing unit 29.

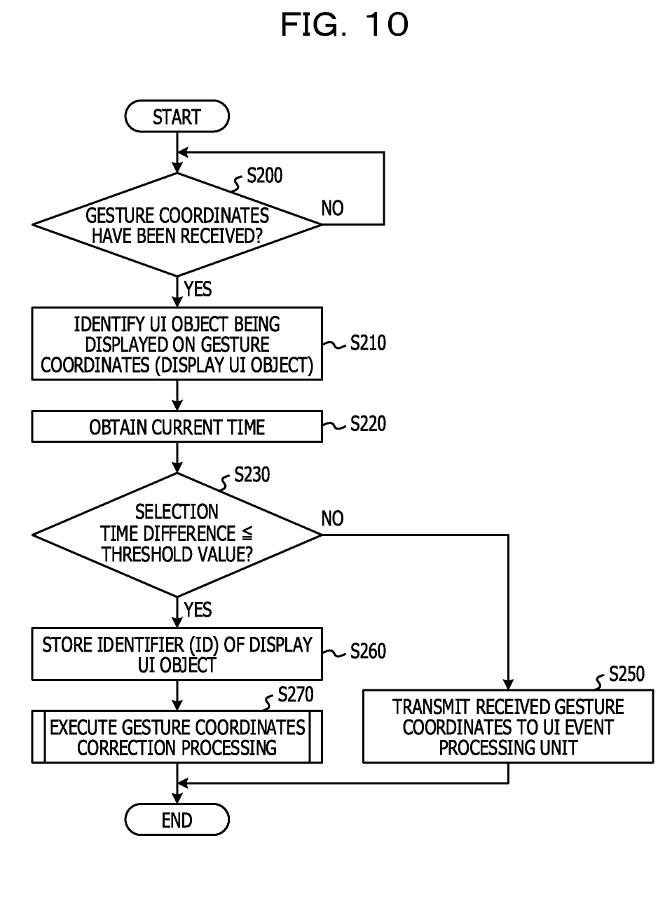

FIG. 10 is a flowchart illustrating an example of a flow of the distribution control processing in the control unit 60A.

Steps S200 to S230 and S250 are similar to the distribution control processing according to the first embodiment illustrated in FIG. 6, so that the description is omitted herein.

In the case of the distribution control processing illustrated in FIG. 10, in the determination processing of Step S230, when the selection time difference is the threshold value or more, the flow proceeds to Step S260.

In Step S260, the control unit 60A refers to the latest screen configuration information 32A indicated by the index 5 of the ring buffer 6, which corresponds to the contents being displayed on the screen. In addition, the control unit 60A stores, in the memory 104, the identifier of the UI object identified in the processing of Step S210, namely, the display UI object, from the latest screen configuration information 32A.

In Step S270, the control unit 60A estimates whether there is a probability of erroneous selection of a display UI object. Then, when a probability of erroneous selection is estimated, the control unit 60A executes gesture coordinates correction processing in which gesture coordinates are corrected so as to be included in the display area of the UI object that the user originally intended to select.

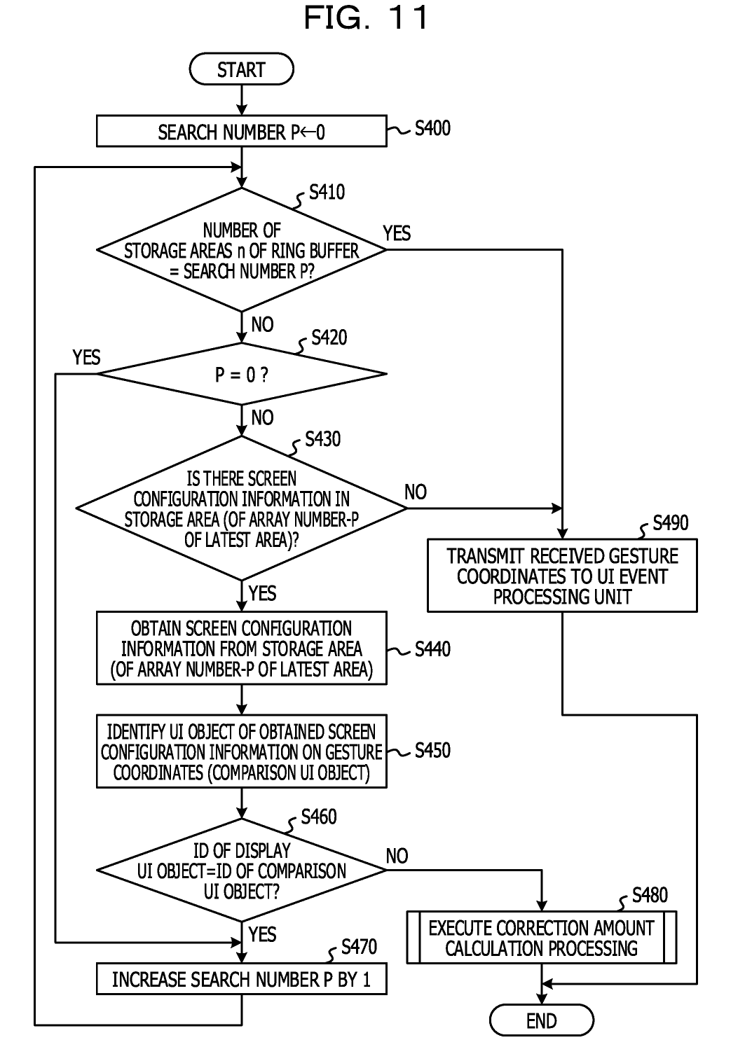

FIG. 11 is a flowchart illustrating an example of a flow of the gesture coordinates correction processing in the control unit 60A.

First, in Step S400, the control unit 60A initializes a search number P indicating the number of times of repetition of the processing of Steps S410 to S470 at 0.

In Step S410, the control unit 60A determines whether or not the search number P matches the number of storage areas n included in the ring buffer 6. As described later, when the control unit 60A executes the processing of Steps S410 to S470 for each of the screen configuration information 32A included in the ring buffer 6, the search number P matches the number of storage areas n included in the ring buffer 6. Namely, the determination processing of Step S410 functions as end determination of the loop processing of Steps S410 to S470 using the screen configuration information 32A included in the ring buffer 6 as a processing target.

When the determination result is negative in the determination processing of Step S410, namely, when the search number P is different from the number of storage areas n included in the ring buffer 6, the flow proceeds to Step S420.

In Step S420, the control unit 60A determines whether or not the search number P is “0”, and when the search number P is “0”, the flow proceeds to Step S470.

Just after the gesture coordinates correction processing illustrated in FIG. 11 has been executed, the search number is initialized at “0” in Step S400, so that the flow proceeds to Step S470 in the determination processing of Step S420.

In Step S470, the control unit 60A increases the search number P by 1, and the flow proceeds to Step S410. When the search number P becomes 1 or more, the flow proceeds to Step S430 in the determination processing of Step S420.

In Step S430, the control unit 60A checks whether the screen configuration information 32A is stored in a storage area the array number of which is indicated by [array number-P of the latest area] (comparison target area), namely, whether or not the storage area is a free area, with reference to the ring buffer 6. The array number of the latest area may be obtained from the index 5. In addition, whether or not the storage area is a free area may be determined according to whether or not a set initial value is stored in the storage area when the communication terminal 2 is started up. The control unit 60A determines that the storage area is a free area when the initial value is stored in the storage area.

In addition, when [array number−P of the latest area] is a negative value s, the control unit 60A checks whether the screen configuration information 32A is stored in a comparison target area using a storage area the array number of which is indicated by (n−|s|) as the comparison target area. The symbol “|s|” indicates an absolute value of the negative value s.

When the determination result is negative in the determination processing of Step S430, namely, when the comparison target area is a free area, the screen configuration information 32A is not included in the comparison target areas that follows the free area, such that it is estimated that the user intended to select a display UI object from the beginning. Thus, the loop processing of Steps S410 to S470 ends, and the flow proceeds to Step S490. On the other hand, when the determination result is affirmative, namely, when the screen configuration information 32A is stored in the comparison target area, the flow proceeds to Step S440.

In Step S440, the control unit 60A obtains the screen configuration information 32A from the comparison target area selected in Step S430. The screen configuration information 32A obtained by the control unit 60A in Step S440 is not the latest screen configuration information 32A corresponding to the contents currently displayed on the display device 30 screen, but the screen configuration information 32A corresponding to the previous contents drawing.

In Step S450, the control unit 60A identifies a UI object located on the gesture coordinates out of the UI objects included in the screen configuration information 32A, with reference to the screen configuration information 32A of the comparison target area obtained in Step S440. Note that the UI object identified from the screen configuration information 32A of the comparison target area in Step S450 is referred to as “comparison UI object”.

In Step S460, the control unit 60A determines whether or not an identifier of the display UI object stored in the memory 104 in Step S260 of FIG. 10 matches an identifier of the comparison UI object identified in Step S450. When the determination result is affirmative in Step S460, namely, when the identifier of the display UI object matches the identifier of the comparison UI object, the flow proceeds to Step S470. Note that as a modified example of the gesture coordinates correction processing illustrated in FIG. 11, when the determination result is affirmative in the Step S460, the loop processing of Steps S410 to S470 ends, and the flow may proceed to Step S490. This is because it is regarded that the UI object intended by the user has been selected when it is determined that the display UI object matches the comparison UI object identified from the screen configuration information 32A at the previous time point in a case in which screen update by plural times does not occur in a short time (for example, the certain time period indicated by the threshold value of Step S230).

Conversely, when the determination result is negative in Step S460, namely, when the identifier of the display UI object does not match the identifier of the comparison UI object, the flow proceeds to Step S480. In this case, it is indicated that the UI object located on the gesture coordinates is updated, such that it is estimated that the user selected a display UI object by mistake because the contents have been updated when the user intended to select a comparison UI object. Thus, in Step S480, in the latest screen configuration information 32A, correction amount calculation processing in which a correction amount of the gesture coordinates is calculated is executed so that the gesture coordinates are included in the display area of the UI object having the same identifier as the comparison UI object. The detail of the correction amount calculation processing is described later.

When an identifier of a comparison UI object of any comparison target area included in the ring buffer 6 matches the identifier of the display UI object, the processing of Steps S410 to S470 is repeated, and the search number P matches the number of storage areas n included in the ring buffer 6. Thus, the flow proceeds to Step S490 in the determination processing of Step S410.

In this case, any screen configuration information 32A stored in the ring buffer 6 indicates that the same UI object is located on the gesture coordinates. Thus, it is estimated that the user intended to select a display UI object from the beginning.

Thus, in Step S490, the control unit 60A outputs the gesture coordinates received in Step S200 of FIG. 10 to the UI event processing unit 29. When the UI event processing unit 29 accepts the gesture coordinates from the control unit 60A, the UI event processing unit 29 executes processing corresponding to the display UI object located on the gesture coordinates.

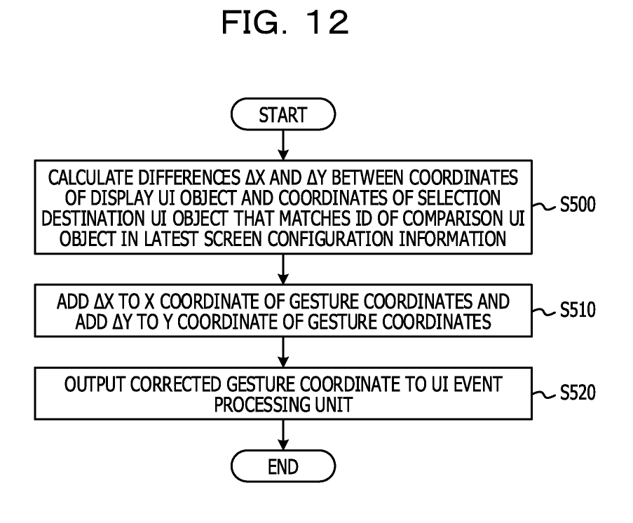

In addition, FIG. 12 is a flowchart illustrating an example of a flow of the correction amount calculation processing in Step S480 of FIG. 11.

First, in Step S500, the control unit 60A obtains an identifier of the comparison UI object determined to have the identifier different from that of the display UI object, in the determination processing in Step S460 of FIG. 11. In addition, the control unit 60A identifies a UI object (selection destination UI object) having the same identifier as the obtained identifier, with reference to the latest screen configuration information 32A.

In addition, the control unit 60A calculates a difference ΔX between the X coordinate of the selection destination UI object and the X coordinate of the display UI object, with reference to the latest screen configuration information 32A. In addition, the control unit 60A calculates a difference ΔY between the Y coordinate of the selection destination UI object and the Y coordinate of the display UI object, with reference to the latest screen configuration information 32A.

In Step S510, the control unit 60A adds the difference ΔX calculated in Step S500 to the X coordinate of the gesture coordinates received in Step S200 of FIG. 10, and adds the difference ΔY calculated in Step S500 to the Y coordinate of the gesture coordinates.

The gesture coordinates to which the difference ΔX and the difference ΔY have been added are included, not in the display area of the display UI object, but in the display area of the selection destination UI object.

Thus, in Step S520, the control unit 60A outputs, to the UI event processing unit 29, the corrected gesture coordinates obtained by adding the difference ΔX and the difference ΔY to the gesture coordinates in Step S510. When the UI event processing unit 29 accepts the corrected gesture coordinates from the control unit 60A, the UI event processing unit 29 executes processing corresponding to the UI object located on the corrected gesture coordinates, namely, the selection destination UI object, with reference to the latest screen configuration information 32A.

As described above, the distribution control processing in the control unit 60A illustrated in FIG. 10 ends.

In Step S400 of FIG. 11, the example is described in which the search number P is initialized at 0, but an initialization method of a search number P is not limited thereto. For example, the search number P may be initialized at 1. In this case, the determination processing of Step S420 may be omitted.

In addition, as the number of storage areas n of the ring buffer 6 is set larger, a probability becomes high that the screen configuration information 32A stored before a time obtained by going back from the current time by the threshold value used in Step S230 of FIG. 10 is stored in the storage area.

For the UI object included in the screen configuration information 32A stored before the time obtained by going back from the current time by the threshold value, a time period since the UI object was displayed until the UI object is selected by the user is relatively long. Thus, such UI object does not have to be included in a determination target of erroneous selection of a UI object due to update of the contents.

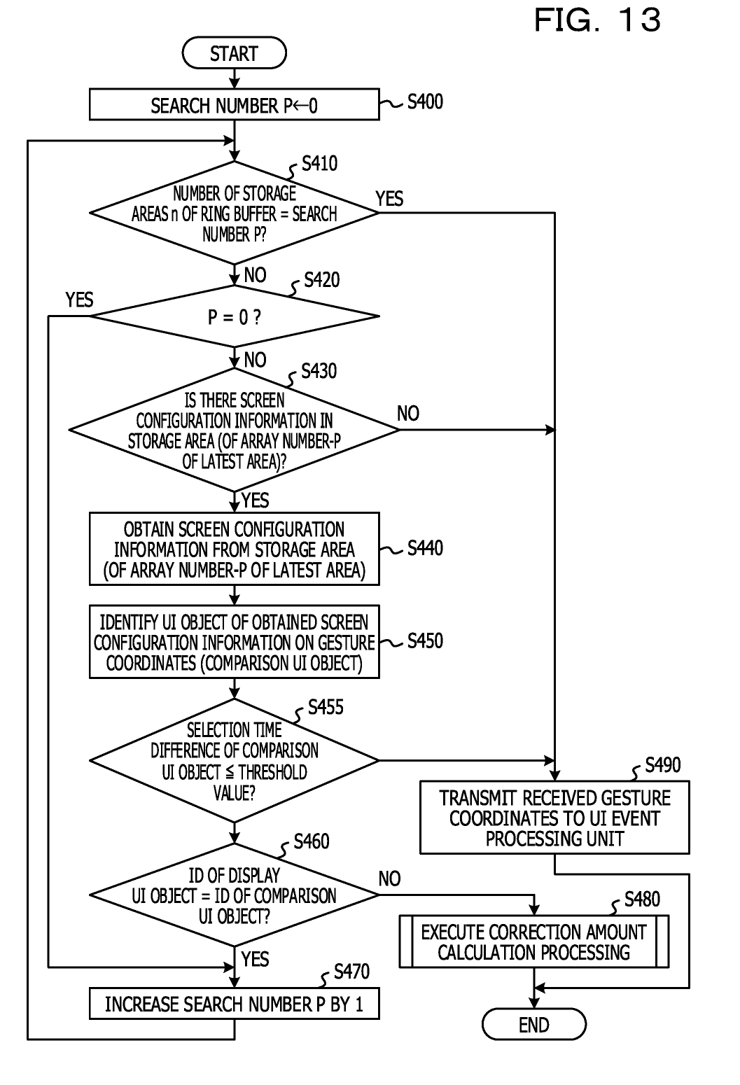

Thus, as illustrated in FIG. 13, Step S455 may be provided between Steps S450 and S460, and when the selection time difference obtained by subtracting the display time of the comparison UI object from the current time is larger than the threshold value, the loop processing of Steps S410 to S470 may be ended.

Specifically, in Step S455, the control unit 60A calculates a selection time difference, based on the display time of the comparison UI object identified in Step S450 and the current time obtained in Step S220 of FIG. 10. Then, the control unit 60A determines whether or not the calculated selection time difference is the threshold value or less, which is used for the determination processing in Step S230 of FIG. 10. When the selection time difference is the threshold value or less, namely, when the determination result is affirmative, the flow proceeds to Step S460, and the control unit 60A determines whether the identifier of the comparison UI object matches the identifier of the display UI object.

On the other hand, when the selection time difference is larger than the threshold value, namely, when the determination result is negative, the flow proceeds to Step S490. This is because it can be regarded that the UI object intended by the user has been selected when the identifier of the comparison UI object matches the identifier of the display UI object over the certain time period indicated by the threshold value of the Step S230.

In this manner, the control unit 60A can improve determination accuracy of whether or not gesture coordinates are to be corrected, by not including a comparison UI object for which the selection time difference calculated from the display time is larger than the threshold value in the determination target of the erroneous selection of a UI object. In addition, a time taken for the gesture coordinates correction processing may be reduced, compared to the case in which the identifier of the comparison UI object is compared with the identifier of the display UI object, for all of the screen configuration information 32A stored in the ring buffer 6.

In addition, as another modified example in which only the screen configuration information 32A stored in the certain time period before the current time is to be included in the determination target of erroneous selection of a UI object, a method can be considered in which the ring buffer 6 is initialized at the timing when the certain time period indicated by the threshold value has elapsed.

In this case, for example, the paint unit 28A outputs to the control unit 60A, drawing completion notification notifying completion of each drawing of the contents.

The control unit 60A starts up a timer, when a set of screen configuration information 32A is included in the ring buffer 6, at the timing at which the drawing completion notification is received from the paint unit 28A. A time-out period of the timer is set at the threshold value used for the determination in Step S230.

When an update of the contents is performed before the timer times out, the screen configuration information 32A corresponding to the updated contents is stored in the ring buffer 6. However, the control unit 60A initializes each of the storage areas of the ring buffer 6 at the initial value when the timer has timed out, and deletes the screen configuration information 32A stored in the ring buffer 6.

Namely, only the screen configuration information 32A stored in the certain time period indicated by the threshold value before the current time is included in the ring buffer 6. Thus, in the gesture coordinates correction processing illustrated in FIG. 11, determination accuracy of whether or not the gesture coordinates are to be corrected may be improved, compared to the case in which the ring buffer 6 is not initialized at the timing at which the certain time period indicated by the threshold value has elapsed.

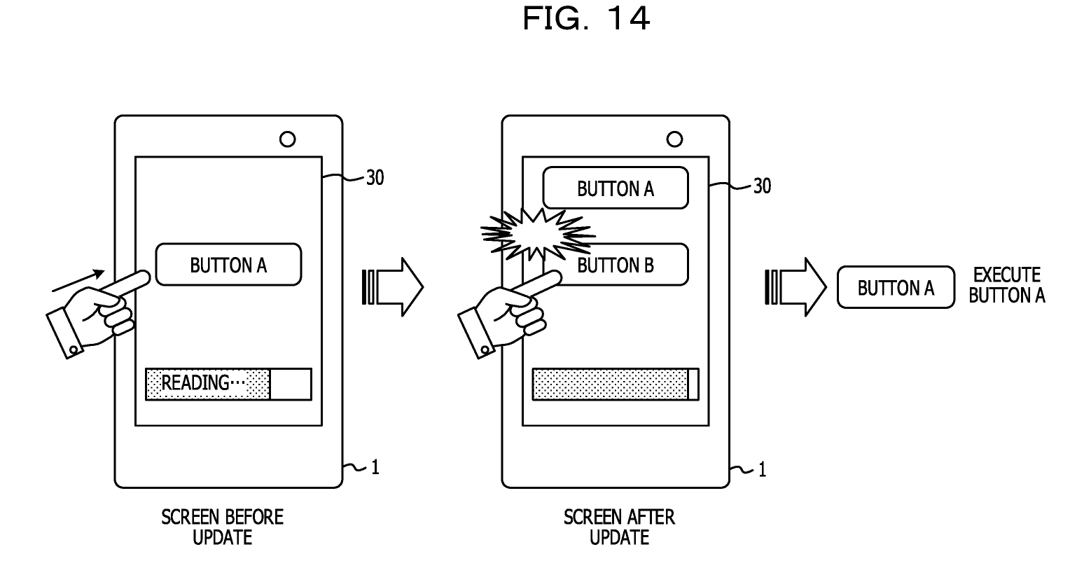

FIG. 14 is a diagram illustrating an example of a UI object selection operation in the communication terminal 2 when the selection time difference is the threshold value or less and the display UI object is different from the comparison UI object. In the example of FIG. 14, the button A is a comparison UI object, and the button B is a display UI object.

Even in a case in which the screen is updated when the user intended to press the button A, with the button B being pressed after the screen update, the communication terminal 2 corrects the gesture coordinates at the time of the button B depression to be within the display area of the button A after the screen update. Thus, processing corresponding to the button B is not executed, and processing corresponding to the button A that the user intended to select is executed, thereby enabling execution of processing according to an operation different from the intention of the user to be suppressed.

In this manner, in the communication terminal 2 according to the second embodiment, the screen configuration information 32A generated for each drawing update of the contents is managed in chronological order using the ring buffer 6. In addition, when the selection time difference of the UI object is the threshold value or less, and the display UI object differs from the comparison UI object, the communication terminal 2 corrects the gesture coordinates such that the same UI object as the comparison UI object is displayed on the screen being displayed.

Thus, for example, even in the case in which the reception status when the contents are received from the server connected to the internet is not good, the contents are received in a fragmented manner, and the screen is updated in phases, in the communication terminal 2, the user is able to select a correct UI object. Namely, this thereby enables execution of processing according to an operation different from the intention of the user due to an update of the screen to be suppressed.

In each of the embodiments, a display time is recorded for each of the UI objects, and the screen configuration information 32A is generated. However, a recording method of display time in the screen configuration information 32A is not limited thereto.

For example, instead of the time drawing ended for each of the UI objects, all UI objects included in the contents at the time of reception may be drawn and the time update of the screen is finished may be recorded as the display time.

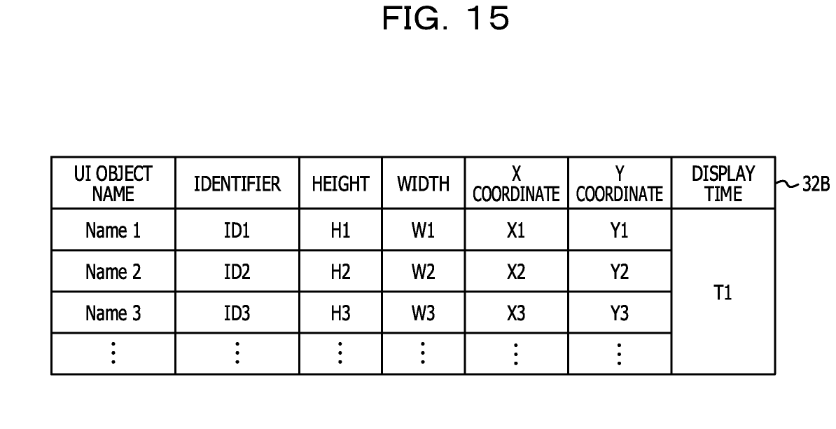

FIG. 15 is a diagram illustrating a modified example of the screen configuration information 32A (screen configuration information 32B). As illustrated in FIG. 15, for example, if a time at which update of the screen is finished is set as “T1”, then a display time of each of the UI objects is indicated by “T1”.

In this case, the display time does not have to be recorded for each of the UI objects, such that a burden to the drawing units 20 and 20A to generate the screen configuration information 32A is reduced compared to the case in which the display time is recorded for each of the UI objects as illustrated in the screen configuration information 32A.

In this manner, a time at any point in the drawing processing of the contents may be used as the display time in the screen configuration information 32A

In addition, the threshold value used for the determination of Step S230 in FIGS. 6 and 10 is not limited to the fixed value, and may be changed according to a reception throughput of the contents.

For example, as the reception status of the contents in the communication line deteriorates reducing reception throughput of the contents, time taken for the display screen drawing to be completed becomes longer. Thus, compared to the case in which a reception throughput of the contents is faster than the current reception throughput, a probability becomes higher that the screen is updated just before the user selects a UI object.

Therefore, by increasing the threshold value in accordance with the extended time taken to complete drawing of the contents, a probability is increased that the selection time difference is the threshold value or less in the determination processing in Step S230 of FIGS. 6 and 10. Thus, execution of processing according to an operation different from the intention of the user may be further suppressed.

On the other hand, as the reception status of the contents in the communication line is improved, and a reception throughput of the contents is heightened, the time taken for the drawing completion of the display screen becomes shorter. Thus, compared to the case in which a reception throughput of the contents is slower than the current reception throughput, a probability becomes low that the screen is updated just before the user selects a UI object.

Accordingly, even when the threshold value is reduced in accordance with a reduction in the time taken for the completion of drawing contents, a probability is low that processing according to an operation different from the intention of the user is executed. For example, when it is detected that a quality of a wireless line used for reception of the contents is a certain value or higher and is favorable, the reception status of the contents in the communication line may be judged good, and a first threshold value may be set. Then, when it is detected that the quality of the wireless line deteriorated to below the certain value, it may be judged that the reception status of the contents in the communication line is not good, and a second threshold value larger than the first threshold value may be set. Thus, when the quality of the wireless line deteriorated, time taken to complete drawing the display screen tends to longer compared to the case in which the quality of the wireless line is good, and thus the threshold value may be increased. As a result, a probability becomes high that the selection time difference is the threshold value or less in the determination processing in Step S230 of FIGS. 6 and 10, and execution of processing according to an operation different from the intention of the user may be further suppressed.

In addition, in each of the embodiments, the example of the screen being updated in phases has been explained above using an example in which the reception status of contents received from the server connected to the internet is not good. However, the example in which the screen is updated in phases is not limited thereto.

For example, in the communication terminals 1 and 2, in a state in which another application different from the device control programs 120 and 120A is executed causing the load of the CPU 102 to be temporarily increased, the screen may be updated in phases when the contents are displayed on the display device 30.

As described above, the technology disclosed herein has been explained based on each of the embodiments, but the technology disclosed herein is not limited to the scope described in each of the embodiments. Various changes or modifications may be made to the embodiments without departing from the gist of the technologies disclosed herein, and the embodiments on which the changes or modifications have been applied may be included in the technical scope of the technologies disclosed herein. For example, the order of processing may be changed without departing from the gist of the technologies disclosed herein.

In addition, in each of the embodiments, the aspects have been described in which the device control programs 120 or 120A are pre-stored (installed) in the storage unit 106, but the embodiment is not limited thereto. The device control program according to the technology disclosed herein may be provided in a form so as to be recorded in the computer readable recording medium 116. For example, the device control program according to the technology disclosed herein may be provided in a form so as to be recorded in a portable recording medium such as a CD-ROM, a digital versatile disc-read only memory (DVD-ROM), or a universal serial bus (USB) memory. In addition, the device control program according to the technology disclosed herein may be provided in a form so as to be recorded in a semiconductor memory or the like such as a flash memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electronic device comprising:
a memory; and
a processor coupled to the memory and the processor configured to:
display an object to a display screen, and
control, when an operation for selecting the object is detected, execution of a processing associated with the object based on a time difference between a first time at which the object is displayed and a second time at which the object is selected.

2. The electronic device according to claim 1, wherein
the processing is executed when the time difference is longer than a threshold value, and the processing is not executed when the time difference is equal to or less than the threshold value.

3. The electronic device according to claim 2, wherein
the processor is configured to execute, when the processing is not executed and another object has been displayed before the first time at substantially same position as the object, another processing associated with the other object.

4. The electronic device according to claim 1, wherein
the first time is a time at which the object is completely displayed.

5. The electronic device according to claim 1, wherein
the processor is configured to obtain data for displaying the object via a network, and the object is displayed based on the data.

6. The electronic device according to claim 1, wherein
the threshold value is set to be larger as a throughput of the data is smaller.

7. A non-transitory computer readable storage medium that stores a program that causes a computer to execute a process comprising:
displaying an object to a display screen; and
controlling, when an operation for selecting the object is detected, execution of a processing associated with the object based on a time difference between a first time at which the object is displayed and a second time at which the object is selected.

8. A device control method comprising:
displaying an object to a display screen; and
controlling, when an operation for selecting the object is detected, execution of a processing associated with the object based on a time difference between a first time at which the object is displayed and a second time at which the object is selected.
